(19) United States
(12) Patent Application Publication
(10) Pub. No.: US 2019/0218400 A1
(43) Pub. Date: Jul. 18, 2019

(54) NOVEL POWDER COATING SYSTEM

(71) Applicant: SWIMC LLC, Cleveland, OH (US)

(72) Inventors: Jigar K. MISTRY, Columbia Heights, MN (US); Victoria GELLING, Medina, MN (US); Justin LALOR, Saint Paul, MN (US); Niteen JADHAV, Plymouth, MN (US); Thomas YUNGBAUER, Woodbury, MN (US)

(73) Assignee: The Sherwin-Williams Company

(21) Appl. No.: 16/076,233

(22) PCT Filed: Feb. 9, 2017
(86) PCT No.: PCT/US2017/017106

§ 371 Date: Aug. 7, 2018

Related U.S. Application Data
(63) Continuation-in-part of application No. PCT/US2016/017323, filed on Feb. 10, 2016.
(60) Provisional application No. 62/293,560, filed on Feb. 10, 2016.
(60) Provisional application No. 62/375,060, filed on Aug. 15, 2016.

(51) Int. Cl. C09D 5/08; C08G 18/22; B01J 23/18

(52) U.S. Cl. CPC C09D 5/084; C08G 18/003; B01J 23/18; C08G 18/227

(57) ABSTRACT

A powder coating composition is described. The composition includes an inorganic bismuth-containing compound or a mixture of inorganic and organic bismuth-containing compounds. The powder composition demonstrates a high degree of cross-linking in the coating and produces a cured coating with optimal crosslinking and corrosion resistance.

### CROSS REFERENCE TO RELATED APPLICATION(S)

This International Application claims the benefit of U.S. Provisional Application Ser. No. 62/293,560, filed 10 Feb. 2016 and entitled “Novel Powder Coating System,” and U.S. Provisional Application Ser. No. 62/375,060, filed 15 Aug. 2016 and entitled “Novel Powder Coating System,” and International Application Serial No. PCT/US2016/017323, filed 10 Feb. 2016 and entitled “Novel Electrodeposition System,” each of which is incorporated herein by reference in its entirety.

### BACKGROUND OF THE INVENTION

Coatings are typically applied to substrates to provide protective and/or decorative qualities. In particular, coatings are often applied to metal surfaces to inhibit or prevent corrosion.

Powder coatings are solvent-free, 100% solids coating systems that have been used as low VOC and low cost alternatives to traditional liquid coatings and paints.

The process of powder coating is well known in the art, and highly crosslinked coatings are desirable for corrosion resistance as well as aesthetic appeal. Typically, such coatings are formed by a reaction between a crosslinkable functional group and a blocked isocyanate group. A catalyst is typically used to promote crosslinking reactions.

A variety of catalysts are known in the art for use with powder coating compositions. Organotin compounds, such as dibutyltin oxide dibutyltin dilaurate (DBTDL), phosphonium bromide compounds, such as ethyl triphenyl phosphonium bromide (ETPPBr), quaternary ammonium salts, amines, and imidazoles and are among the known catalysts used in powder coating compositions. However, each of these types of catalysts exhibits certain drawbacks. For example, organotin catalysts like DBTDL are increasingly scrutinized for the alleged human health risks and environmental issues associated with these compounds.

Moreover, many of these catalysts do not exhibit the superior latency, thermal stability, and controlled reactivity desirable for a catalyst, and may exhibit odor, discoloration, or material handling hazards.

Certain bismuth-containing compounds have been suggested as a replacement for conventional catalysts, notably in electrocoating processes. These include organic bismuth-containing catalysts such as the bismuth salts of carboxylic and hydroxy carboxylic acids. However, many of these organic bismuth-containing compounds are liquid and cannot be easily incorporated into a powder coating composition.

From the foregoing, it will be appreciated that what is needed in the art is an effective catalyst for powder coating that is substantially or even completely free of organotin compounds but can be easily incorporated into a powder composition without losing desirable cured film properties such as corrosion resistance. Such catalysts, compositions containing such catalysts, and methods for preparing and using the catalysts and compositions are disclosed and claimed herein.

### BRIEF DESCRIPTION OF FIGURES

FIG. 1 is a graphical representation of corrosion testing of metal panels coated with various powder compositions and exposed to salt fog.

FIG. 2 is a graphical representation of electrochemical impedance spectroscopy (EIS) testing of metal panels coated with various powder compositions and exposed to salt fog.

### SUMMARY

The present description provides a powder coating compositions and methods. Preferred coatings formed from the powder composition described herein provide optimal crosslinking and performance characteristics, including enhanced corrosion resistance.

In one embodiment, the present description provides a powder coating composition that includes an inorganic bismuth-containing compound.

In another embodiment, the present description provides a powder coating composition that includes a binder resin component including at least one crosslinkable polymer resin component, a crosslinking component, and at least an inorganic bismuth-containing compound.

In yet another embodiment, the present description provides a method including steps for combining a binder resin component that includes at least one crosslinkable polymer resin with a blocked isocyanate component, and at least an inorganic bismuth-containing compound.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### SELECTED DEFINITIONS

Unless otherwise specified, the following terms as used herein have the meanings as provided below.

The term “component” refers to any compound that includes a particular feature or structure. Examples of components include compounds, monomers, oligomers, polymers, and organic groups contained there.

The term “crosslinker” refers to a molecule capable of forming a covalent linkage between polymers or between two different regions of the same polymer. The term is used interchangeably with “curing agent,” “crosslinking agent,” or “crosslinking component.”

The term “dispersion” in the context of a dispersible polymer refers to the mixture of a dispersible polymer and a carrier. The term “dispersion” is intended to include the term “solution.”

The term “tin-containing compound” is used herein as a reference to various tin compounds including organotin compounds such as dibutyl tin oxide, for example, that are currently subject to regulatory concern, restriction or prohibition. “Tin-free” or “label-free” is used herein to indicate compounds that do not contain such compounds, although tin may still be present in other forms.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “catalytic effect,” or “catalytically effective” as used herein refers to the ability of a component in a coating composition to facilitate effective crosslinking of the composition. In this context, a catalytic effect exists when a cure response occurs. A better catalyst provides faster cure or cure at a lower cure temperature or both, relative to a control catalyst.

Unless otherwise indicated, the term “polymer” includes both homopolymers and copolymers (i.e., polymers of two or more different monomers).

The term “comprises” and variations thereof do not have a limiting meaning where these terms appear in the description and claims.

The term “providing,” as used herein, is intended broadly to include making available, supplying, or obtaining a component, substrate, part, or the like. The term may include manufacturing, but also obtaining via purchasing, supplying via sale, or other types of transfer of a component, substrate, part, or the like.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides a powder coating composition including an inorganic bismuth-containing compound. The composition is presently believed to be useful with any type of powder coating composition and in any process involving powder coatings.

The present description provides powder coating compositions and methods. The composition preferably includes a binder component including at least one crosslinkable polymer resin component, an optional crosslinking component, and at least an inorganic bismuth-containing compound. The method described herein preferably includes combining the binder resin component with the blocked isocyanate component and at least an inorganic bismuth-containing compound to produce a powder coating composition.

In an embodiment, the present description provides a powder coating composition. The composition includes a binder component that includes one or more polymeric resin components including at least a polymeric binder. Suitable polymeric binders generally include a film forming resin and optionally a crosslinking agent or curing agent for the resin. The binder may be selected from any resin or combination of resins that provides the desired film properties. Suitable examples of polymeric binders include thermoset and/or thermoplastic materials, and can be made with epoxy, polyester, polyurethane, polyamide, acrylic, polyvinylchloride, nylon, fluoropolymer, silicone, other resins, or combinations thereof. Thermoset materials are preferred for use as polymeric binders in powder coating applications, and epoxies, polyesters and acrylics are particularly preferred. If desired, elastomeric resins may be used for certain applications. In an aspect, specific polymeric binders or resins are included in the powder compositions described herein depending on the desired end use of the powder-coated substrate. For example, certain high molecular weight polyesters show superior corrosion resistance and are suitable for use on substrates used for interior and exterior applications.

In an aspect, at least one of the polymeric resin components may be a resin having crosslinkable functionality. For example, the polymeric resin component may have hydroxyl, isocyanate, amine, epoxy, acrylate, vinyl, silane, carbamate, acetoacetate functionality, or any suitable combination of such functionality, and so on.

Examples of preferred binder components include, without limitation, the following: carboxyl-functional polyester resins cured or crosslinked with epoxide-functional compounds (e.g., triglycidyl-isocyanurate or TGIC coatings, commercially available as POWDURA (Sherwin Williams), INTERPON D1000 and D2000 (Akzo), VALDE (Valspar), and the like), carboxyl-functional polyester resins cured or crosslinked with polymeric epoxy resins, carboxyl-functional polyester resins cured or crosslinked with hydroxyalkyl amides (commercially available as PRIMID coatings (EMS Griltech)), hydroxyl-functional polyester resins cured or crosslinked with blocked isocyanates or uretdiones, epoxy resins cured or crosslinked with amines (e.g., dicyandiamide), epoxy resins cured or crosslinked with phenolic-functional resins, epoxy resins cured or crosslinked with carboxyl-functional curatives, carboxyl-functional acrylic resins cured or crosslinked with polymeric epoxy resins, hydroxyl-functional acrylic resins cured or crosslinked with blocked isocyanates or uretdiones, unsaturated resins cured or crosslinked through free radical reactions, and silicone resins used either as the sole binder or in combination with organic resins. The optional curing reaction may be induced thermally, or by exposure to radiation (e.g., UV, UV-vis, visible light, IR, near-IR, and e-beam). In a preferred aspect, the binder includes at least a hydroxyl-functional polyester cured with a blocked polyisocyanate.

In an embodiment, the binder component is present in an amount of about 40 to 95, preferably about 55 to 80, and more preferably about 60 to 70 percent by weight, based on the total weight of the composition.

In a preferred aspect, the binder component is a combination of a hydroxyl-functional polyester resin and a Type 2 epoxy resin, i.e. a solid epoxy resin having an epoxy equivalent weight of approximately 600. The hydroxyl-functional polyester is present in an amount of preferably about 25 to 95, more preferably 30 to 75, and most preferably 40 to 55 percent by weight, based on the total weight of the composition. The epoxy resin is present in amount of preferably about 1 to 25, more preferably about 2 to 20, and most preferably about 5 to 15 percent by weight, based on the total weight of the composition.

In an aspect, the resin component is self-crosslinking, and in another aspect, the resin component is crosslinkable with an optional crosslinking agent reactive with the functional group(s) of the resin component.

Suitable optional crosslinking agents for use in the compositions and method described herein include, for example, aminoplast resins, polyisocyanates, polyepoxides, polyacids and polyamines, combinations or mixtures thereof, and the like.

In a preferred aspect, the crosslinking agent is a polyisocyanate. Examples of suitable polyisocyanates include, without limitation, aromatic, alicyclic, or aliphatic polyisocyanate compounds, preferably diisocyanate compounds such as toluene diisocyanate (TDI), xylylene diisocyanate (XDI), toluene xylylene diisocyanate (TMXDI), phenylene diisocyanate, tetramethylene diisocyanate, hexamethylene diisocyanate (HMDI), methylene diisocyanate, methylene diphenyl diisocyanate (MDI), isophorone diisocyanate (IPDI), isocyanate prepolymers, combinations or mixtures thereof, and the like. In a preferred aspect, the polyisocyanate used as a crosslinking agent for the resin component described herein is methylene diphenyl diisocyanate (MDI). Such crosslinkers are well known in the art, and are described in numerous patents including, for example, U.S. Pat. Nos. 3,894,922; 3,947,339; 3,984,299; 3,959,106; 4,017,438; 4,038,232; 4,031,050, 4,101,486; 4,134,816; 4,176,221; 4,182,831; 4,182,833; 4,225,478; 4,225,479; 4,260,697; 4,297,255; 4,310,646; 4,393,179; 4,339,369; 4,452,681; 4,452,930; and 4,452,963.

Preferred polyisocyanate crosslinking agents for use herein include a blocked polyisocyanate. Suitable blocking agents include, for example, (a) lactam compounds, such as ε-caprolactam, γ-caprolactam, etc., (b) oxime compounds, such as methyl ethyl ketoxime, etc., (c) phenols, such as phenol, p-t-butylphenol, cresol, etc., (d) aliphatic alcohols, such as butanol, 2-ethyl hexanol, etc., (e) active-hydrogen group-containing compounds including, for example, aromatic alcohols, such as phenyl carbitol, methyl phenyl carbitol, etc., dialkyl compounds such as diethyl malonate, dimethyl pyrazole, and the like, and (f) ether alcohols, and the like.

In an embodiment, where the resin component is self-crosslinking, no additional crosslinking agent is required, but one or more crosslinking agents may still be used. In another embodiment, the crosslinking agent is present in an amount from about 1 to 60, preferably 10 to 45, and more preferably 20 to 40 percent by weight, based on the total weight of the composition.

The powder coating composition described herein further includes an organotin-free compound, which, in some systems, may function as a cure catalyst, a corrosion inhibitor, or both. Without limiting to theory, in some embodiments it is believed that a catalyst may help unblock the blocked polyisocyanate for crosslinking with crosslinkable functionality on the polymeric backbone of the resin component during the cure process (e.g., heating or baking to a temperature of about approximately 176° C.).

In an embodiment, suitable organotin-free compounds for use in the compositions and methods described herein preferably include inorganic bismuth-containing compounds, preferably multivalent bismuth salts of various anions, more preferably bismuth salts of metal oxyanions. These compounds include the anhydrous forms, as well as various hydrates, including hemihydrate, pentahydrate and other hydrated forms, along with mixtures and combinations thereof, and the like.

Suitable examples of such bismuth salts of various anions include, without limitation, bismuth silicate, bismuth magnesium aluminosilicate, bismuth aluminate, bismuth borate, bismuth manganate, bismuth hydroxide, bismuth trioxide, bismuth phosphate, and the like. In a preferred aspect, the inorganic bismuth-containing compound is a bismuth salt of a metal oxyanion, such as, for example, bismuth aluminate, bismuth manganate, and mixtures or combinations thereof, and the like

In an embodiment, suitable organotin-free compounds preferably include inorganic bismuth-containing compounds that are solid. Examples of solid inorganic bismuth-containing compounds include, without limitation, bismuth silicate, bismuth magnesium aluminosilicate, bismuth aluminate, bismuth borate, bismuth manganate, bismuth hydroxide, bismuth trioxide, bismuth phosphate, as well as various hydrates, including hemihydrate, pentahydrate and other hydrated forms, along with mixtures and combinations thereof, and the like.

In a preferred embodiment, the inorganic bismuth-containing compound is bismuth aluminate, preferably bismuth aluminate hydrate, commercially available from various sources, including Sigma-Aldrich, for example. Bismuth aluminate and bismuth aluminate hydrate may be associated with small amounts of other inorganic bismuth-containing compounds, including bismuth trioxide and bismuth hydroxide, for example.

In some embodiments, the inorganic bismuth-containing compound may be used in combination with one or more organic bismuth-containing compounds. Any previously disclosed organic bismuth-containing compound may be used herein. Compounds of this type are described, for example, in U.S. Pat. Nos. 5,554,700; 5,631,214; 5,670,441; 5,859,165; 6,353,057; and 6,190,524.

Suitable examples of organic bismuth-containing compounds include bismuth acetate, bismuth subacetate, bismuth carbonate, bismuth salicylate, bismuth subsalicylate, bismuth subcarbonate, bismuth subcitrate, bismuth citrate, bismuth benzoate, bismuth oxalate, bismuth oleate, bismuth dialkyldithiocarbamates, hydroxy acids of bismuth, organosulfur bismuth compounds, reaction products of bismuth with mercaptans and/or hydroxy mercaptans, mixtures or combinations thereof, and the like.

In an embodiment, the combination of the inorganic bismuth-containing compound with an organic bismuth-containing compound is a solid that can be readily blended with other components of a powder coating composition. In a preferred aspect, the combination is a solid mixture of the inorganic and organic bismuth-containing compound, preferably a mixture of bismuth aluminate and bismuth citrate.

In some embodiments, the inorganic bismuth-containing compounds may be used in combination with a polyvalent metal catalyst, including, for example, metallic bismuth, zinc, cadmium, lead, iron, cobalt, nickel, barium, strontium, copper, zirconium, tin, chromium, and the like.

In some embodiments, the inorganic bismuth-containing compound may be used in combination with conventional catalysts used in powder coating systems including DBTDL, ETPPBr, quaternary ammonium salts, amines, imidazoles, and the like, for example.

In an embodiment, the inorganic bismuth-containing compound is present in a catalytically effective amount. By “catalytically effective” is meant an amount sufficient to provide optimal cure of the powder coating composition, assuming standard temperature conditions and time for cure, typically 15 minutes at about 325 F to 375 F. In an aspect, the inorganic bismuth-containing compound is present in an amount of about 0.1 to 10, more preferably 0.5 to 8, and even more preferably 1 to 5 percent by weight, based on the total weight of the coating composition. If the inorganic bismuth-containing compound is used in conjunction or combination with an organic bismuth-containing compound or other catalyst, the inorganic bismuth-containing composition is present in a ratio by weight with the organic bismuth-containing compound of 10:1 to 1:1, 5:1 to 1:1, 1.25:1 to 1:1, and the like. Optimally, the inorganic bismuth-containing composition is present in a ratio by weight with the organic bismuth-containing compound of about 1:1 preferably 1:0.1 to 1:1, 1:0.5 to 1:1, 1:0.75 to 1:1, and the like.

In an embodiment, the inorganic bismuth-containing compound is present in a catalytically effective amount, whether used alone or in combination with other catalysts, including organic bismuth-containing compounds.

The powder composition described herein includes an inorganic bismuth-containing compound, preferably bismuth aluminate (or a hydrate thereof), and demonstrates optimal corrosion resistance and catalytic activity.

Many powder coating compositions tend to discolor or yellow when overbaked, e.g., baked for longer bake times and/or at higher temperatures. Some compositions, especially semi-gloss or matte compositions, may also change their appearance during overbaking. Surprisingly, the powder compositions described herein that include an inorganic bismuth-containing compound, preferably bismuth aluminate (or a hydrate thereof), do not show significant discoloration or change in gloss when overbaked.

In an embodiment, the inorganic bismuth-containing compounds used herein may be corrosion inhibitors, either used alone or in combination with organic bismuth-containing compounds and/or other corrosion inhibitors known in the art. The use of inorganic bismuth-containing compounds as corrosion inhibitors is further described in Applicant's patent applications, including previously filed International Application No. PCT/US2016/017323, entitled “Novel Electrodeposition System” (filed 10 Feb. 2016), claiming priority to U.S. Provisional Application No. 62/114,228 (filed 10 Feb. 2015), and U.S. Provisional Application No. 62/293,628 (filed 10 Feb. 2016) entitled “Corrosion Resistant Coating Composition.”

In an embodiment, the inorganic bismuth-containing compound is present in an amount sufficient to inhibit corrosion. In an aspect, the inorganic bismuth compound is present in an amount of about 0.5 to 10, more preferably 0.6 to 5 percent by weight, based on the total weight of the coating composition. If the inorganic bismuth-containing compound is used in conjunction or combination with an organic bismuth-containing compound or other catalyst, the inorganic bismuth-containing composition is present in a ratio by weight with the organic bismuth-containing compound of 10:1 to 1:1, 5:1 to 1:1, 1.25:1 to 1:1, and the like. Optimally, the inorganic bismuth-containing composition is present in a ratio by weight with the organic bismuth-containing compound of about 1:1 preferably 1:0.1 to 1:1, 1:0.5 to 1:1, 1:0.75 to 1:1, and the like.

In an embodiment, a cured coating made from the composition and method described herein will demonstrate comparable corrosion resistance, preferably superior corrosion resistance, to conventional powder coatings made without the inorganic bismuth-containing compositions.

The powder compositions described herein may optionally be colored with dyes or pigments. Various organic or inorganic coloring pigments may be used in the present invention. Suitable coloring pigments include titanium dioxide (TiO₂), carbon black, red iron oxide, yellow iron oxide, raw umber, phthalocyanine blue, phthalocyanine green, naphthol red, toluidine red, various organic yellows, carbazole violet, and quinacridones. If desired, processed coloring pigments, such as pigments that have been coated with polymeric materials may be used. Suitable such pigments include SURPASS products from Sun Chemical.

The powder compositions described herein may optionally include other additives. These other additives can improve the application of the powder coating, the melting and/or curing of that coating, or the performance or appearance of the final coating. Examples of optional additives which may be useful in the powder include: cure catalysts, antioxidants, color stabilizers, slip and mar additives, UV absorbers, hindered amine light stabilizers, photoinitiators, conductivity additives, tribocharging additives, anti-corrosion additives, fillers, texture agents, degassing additives, flow control agents, thixotropes, and edge coverage additives.

Conventionally, the polymeric binder is dry mixed together with any optional additives, and then is melt blended by passing through an extruder. The resulting extrudate is solidified by cooling, and then ground or pulverized to form a powder. Other methods may also be used. For example, one alternative method uses a binder that is soluble in liquid carbon dioxide. In that method, the dry ingredients are mixed into the liquid carbon dioxide and then sprayed to form the powder particles. If desired, powders may be classified or sieved to achieve a desired particle size and/or distribution of particle sizes.

The resulting powder is at a size that can effectively be used by the application process. Practically, particles less than 10 microns in size are difficult to apply effectively using conventional electrostatic spraying methods. Consequently, powders having median particle size less than about 25 microns are difficult to electrostatically spray because those powders typically have a large fraction of small particles. Preferably the grinding is adjusted (or sieving or classifying is performed) to achieve a powder median particle size of about 25 to 150 microns, more preferably 30 to 70 microns, most preferably 30 to 50 microns.

Optionally, other additives may be used in the present invention. As discussed above, these optional additives may be added prior to extrusion and be part of the base powder, or may be added after extrusion. Suitable additives for addition after extrusion include materials that would not perform well if they were added prior to extrusion; materials that would cause additional wear on the extrusion equipment, or other additives.

Additionally, optional additives include materials which are feasible to add during the extrusion process, but may also be added later. The additives may be added alone or in combination with other additives to provide a desired effect on the powder finish or the powder composition. These other additives can improve the application of the powder, the melting and/or curing, or the final performance or appearance. Examples of optional additives which may be useful include: cure catalysts, antioxidants, color stabilizers, slip and mar additives, UV absorbers, hindered amine light stabilizers, photoinitiators, conductivity additives, tribocharging additives, anti-corrosion additives, fillers, texture agents, degassing additives, flow control agents, thixotropes, and edge coverage additives.

For example, additives may include various inorganic or organic pigments that are added to provide colored powder coating compositions. For example, these pigments may be added to a base powder composition to produce colored powders, as described, in U.S. Pat. Nos. 7,019,051; 7,649,034; 7,867,555; 9,156,996, etc.

The powder compositions described herein may optionally include additives that improve the electrostatic application characteristics of the powder coating compositions. Suitable additives of this type include, for example, extrudable application additives, fumed metal oxides, combinations thereof, and the like. In an aspect, the application additive is added to the raw material before extrusion, and other additives such as the metal oxide, for example, can be added later, during grinding or pulverization of the composition.

Other additives include performance additives such as rubberizers, friction reducers, and microcapsules. Additionally, the additive could be an abrasive, a heat sensitive catalyst, an agent that helps create a porous final coating, or that improves wetting of the powder.

Techniques for preparing low flow and high flow powder compositions are known to those of skill in the art. Mixing can be carried out by any available mechanical mixer or by manual mixing. Some examples of possible mixers include Henschel mixers (available, for example, from Henschel Mixing Technology, Green Bay, Wis.), Mixaco mixers (available from, for example, Triad Sales, Greer, SC or Dr. Herfeld GmbH, Neuenrade, Germany), Marion mixers (available from, for example, Marion Mixers, Inc., 3575 3rd Avenue, Marion, Iowa), invertible mixers, Littleford mixers (from Littleford Day, Inc.), horizontal shaft mixers and ball mills. Preferred mixers would include those that are most easily cleaned.

Powder coatings are generally manufactured in a multi-step process. Various ingredients, which may include resins, catalysts, curing agents, pigments, additives, and fillers, are dry-blended to form a premix. This premix is then fed into an extruder, which uses a combination of heat, pressure, and shear to melt fusible ingredients and to thoroughly mix all the ingredients. The extrudate is cooled to a friable solid, and then ground into a powder. Depending on the desired coating end use, the grinding conditions are typically adjusted to achieve a powder median particle size of about 25 to 150 microns.

In a preferred, the binder component including a hydroxyl-functional polyester resin and a Type 2 epoxy resin is dry-blended with the crosslinking agent and at least the inorganic-bismuth containing compound to form a premix. The premix is extruded to form the powder coating composition described herein.

The final powder may then be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating. Other alternatives such as UV curing of the coating may be used.

The coating is optionally cured, and such curing may occur via continued heating, subsequent heating, or residual heat in the substrate. In another embodiment of the invention, if a radiation curable powder coating base is selected, the powder can be melted by a relatively short or low temperature heating cycle, and then may be exposed to radiation to initiate the curing process. One example of this embodiment is a UV-curable powder. Other examples of radiation curing include using UV-vis, visible light, near-IR, IR and e-beam.

The compositions and methods described herein may be used with a wide variety of substrates. Typically and preferably, the powder coating compositions described herein are used to coat metal substrates, including without limitation, unprimed metal, clean-blasted metal, and pretreated metal, including plated substrates and ecoat-treated metal substrates. Typical pretreatments for metal substrates include, for example, treatment with iron phosphate, zinc phosphate, and the like. Metal substrates can be cleaned and pretreated using a variety of standard processes known in the industry. Examples include, without limitation, iron phosphating, zinc phosphating, nanoceramic treatments, various ambient temperature pretreatments, zirconium containing pretreatments, acid pickling, or any other method known in the art to yield a clean, contaminant-free surface on a substrate.

The coating compositions and methods described herein are not limited to conversion coatings, i.e. parts or surfaces treated with conversion coatings. Moreover, the coating compositions described herein may be applied to substrates previously coated by various processes known to persons of skill in the art, including for example, ecoat methods, plating methods, and the like. There is no expectation that substrates to be coated with the compositions described herein will always be bare or unprimed metal substrates.

Preferably, the coated substrate has desirable physical and mechanical properties, including optimal edge coverage of sharp edges and surface smoothness. Typically, the final film coating will have a thickness of 25 to 200 microns, preferably 50 to 150 microns, more preferably 75 to 125 microns.

The powder coating compositions described herein may be used in a wide variety of applications, including, without limitation, household appliances (e.g., refrigerators, grills, kitchen mixers, faucets, water heaters, power tools, office furniture, cabinetry, shelving, etc.), automotive (various components including steering wheels, interior trim, manifolds, light housing, seat frames, seat belt mounts and latches, filters, shock absorbers, engine blocks, coil springs, motor housings, etc.), electronics (e.g., switch boxes, transformers, electric meters, connectors, motor parts, flooring, etc.), and functional coatings (e.g., interior and exterior pipe coatings, rebar coatings, concrete cables, structural steel, conduits, heavy machinery, off-road vehicles, agricultural machinery and vehicles, military hardware, military projectiles, etc.).

In a preferred aspect, when used in the methods described herein to form a powder coating composition, the inorganic bismuth-containing compound demonstrates optimal catalytic effect. To determine catalytic effect, the powder coating is assessed for solvent resistance according to the solvent double rub method of ASTM D5402-15, as further described below. An optimally or effectively cured coating will remain intact after at least 30 solvent double rubs, preferably 40 solvent double rubs, even more preferably 50 solvent rubs, and optimally even 100 rubs.

The catalytic effect of the inorganic bismuth-containing compound may also be determined by measuring the amount of time it takes for a powder composition as described herein to completely gel after exposure to a heat source at 350° F. (177° C.) or 400° F. (204° C.). An optimally or effectively cured coating will demonstrate preferably at least a 10%, more preferably 15% and most preferably 20% reduction in gel time relative to a control composition that does not contain the inorganic bismuth-containing compound.

In a preferred aspect, the powder coating made using the methods described herein demonstrates optimal corrosion resistance. Coated test panels are scribed to metal and exposed to salt fog according to the method of ASTM D1654-08, as further described below. A corrosion-resistant coating will demonstrate minimal paint loss or creep from scribe of preferably less than about 4 mm, more preferably less than about 3 mm, even more preferably less than 2 mm.

The resulting coated article desirably includes a coating that provides excellent corrosion protection and optimal smoothness, while also being an environmentally friendly tin-free system.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Missouri.

### Test Methods

Unless indicated otherwise, the following test methods were utilized in the Examples that follow.

### Solvent Resistance Test

The extent of “cure” or crosslinking of a coating is measured as a resistance to solvents, such as methyl ethyl ketone (MEK). This test is performed as described in ASTM D 5402-15 (Standard Practice for Assessing the Solvent Resistance of Organic Coatings Using Solvent Rubs). For the test, powder films are tested one hour after cure and while the films are at room temperature. The films have average film thickness of 50 to 75 μm and are applied on 0.05 cm-thick cold-rolled steel panels. The number of double-rubs (i.e., one back-and-forth motion) is reported.

### Corrosion Resistance Test

The corrosion resistance of cured coatings prepared from the composition described herein is tested by measuring creep after exposure to a corrosive environment, as described in ASTM D1654-08 (Standard Test Method for Evaluation of Painted or Coated Specimens Subjected to Corrosive Environments). For the test, powder films are tested one hour after cure, while the films are at room temperature. The films have average film thickness of 50 to 75 μm and are applied electrostatically on 0.05 cm thick cold-rolled steel panels at 70 kV. Each panel is then scribed to metal and exposed to salt fog for a given period of time. Paint loss from the scribe is measured, and results are expressed as the amount of creep (in mm) from the scribe.

### Gel Time Test (Stick)

The extent of “cure” or crosslinking of a coating can be measured as a function of the time taken for the coating to gel on the application of heat. For the test, a 1.25 mL sample of powder is poured in the center of the hotplate (or other heat source) at a temperature of 350° F. (approx. 177° C.) depending on the specification and stirred immediately with a wooden stick applicator. The gel time of the coating refers to the time elapsed from initial contact of the powder with the heat source to the time when the film completely gels, i.e. when the film is no longer fluid and strings break.

### Gel Time Test (CSA)

This test is performed as described in Canadian Standards Association CAN/CSA-Z245.20-10 External Fusion Bond Epoxy Coating for Steel Pipe and also measures the extent of crosslinking as a function of the time take for the coating to gel. For the test, a small amount of powder is scooped onto a CSA drawdown tool, which has a 25 mm wide groove cut 0.08 to 0.1 cm (30-40 mils) deep. The powder is then deposited on a gel plate at an angle of 45° and a temperature of 400° F. (approx. 204° C.), and drawn down repeatedly on the gel plate until the powder has completely gelled and the drawdown tool does not make contact with the plate.

### Electrochemical Impedance Spectroscopy (EIS)

Electrochemical impedance spectroscopy (EIS) is a standard method used to determine the impedance value of a cured coating. Substrates or test panels coated with films are prepared and placed under a glass cell filled with an electrolyte (5% NaCl solution) along with a second electrode. The initial impedance of each panel is measured using a spectrometer (Gamry Instrument Framework Potentiostat Reference 600)).

### Example 1

### Preparation of Powder Coating Formulations

Powder coating formulations #1 to #8 were prepared according to Table 1. For each powder type, control formulations #1, #4 and #7 (i.e. uncatalyzed formulations) and formulations #2, #3, #5, #6 and #8 containing bismuth aluminate hydrate at either 1% or 5% based on total weight of the formulation were prepared. The powder coating compositions were applied electrostatically on test panels as described above. The applied coatings were cured for 15 minutes at 325° F. (162.8° C.) for TGIC-based formulations and 15 minutes at 375° F. (190.6° C.) for PRIMID coatings and for polyurethane coatings.

TABLE 1
Powder Compositions

| | | Bismuth Aluminate | Bismuth Aluminate |
|---|---|---|---|
| Sample | Description | (1%) | (5%) |
| 1 | TGIC (control) | −− | −− |
| 2 | TGIC | + | −− |
| 3 | TGIC | −− | + |
| 4 | Primid (control) | −− | −− |
| 5 | Primid | + | −− |
| 6 | Primid | −− | + |
| 7 | Polyurethane | −− | −− |
| | (control) | | |
| 8 | Polyurethane | −− | + |

### Example 2

### Catalytic Effect

To test catalytic activity of the inorganic bismuth-containing compound, the CSA gel time at 400° F. (approx. 204° C.) and stir stick gel time at 350° F. (approx. 177° C.) for the control powder formulations and for formulations containing bismuth aluminate at 5% by weight as shown in Table 1 were determined. Results are shown in Table 2. A decrease in gel time indicates enhanced catalytic activity.

TABLE 2
Catalytic Effect

| | CSA Gel time | Stir stick Gel time |
|---|---|---|
| Sample | (sec) | (sec) |
| 1 | 56.77 | 85.5 |
| 3 | 49.58 | 109 |
| 4 | 78.57 | 124 |
| 6 | 61.64 | 130 |
| 7 | 33.85 | 67 |
| 8 | 29.07 | 56 |

### Example 3

### Cure Performance

To determine cure performance as a function of cure temperature, the powder formulations #1 to #8 as shown in Table 1 were coated on cold-rolled steel panels, cured for 15 minutes at 350° F. (approx. 177° C.) and 375° F. (190.5° C.) and allowed to dry. Each panel was then tested for solvent resistance using the MEK double rub method. Results are shown in Table 3, where +++ represents 100 double rubs without loss of film from the panel. Films with a +++ rating in Table 3 demonstrate optimal or effective cure of the coated film at the indicated temperature.

TABLE 3
Cure performance

| Sample | Cure (min/° F.) | MEK double rubs |
|---|---|---|
| 1 | 15/350 | + |
| | 15/375 | +++ |
| 2 | 15/350 | + |
| | 15/375 | +++ |
| 3 | 15/350 | + |
| | 15/375 | +++ |
| 4 | 15/350 | + |
| | 15/375 | +++ |
| 5 | 15/350 | + |
| | 15/375 | +++ |
| 6 | 15/350 | + |
| | 15/375 | +++ |
| 7 | 15/350 | + |
| | 15/375 | +++ |
| 8 | 15/350 | +++ |
| | 15/375 | +++ |

### Example 4

### Corrosion Resistance

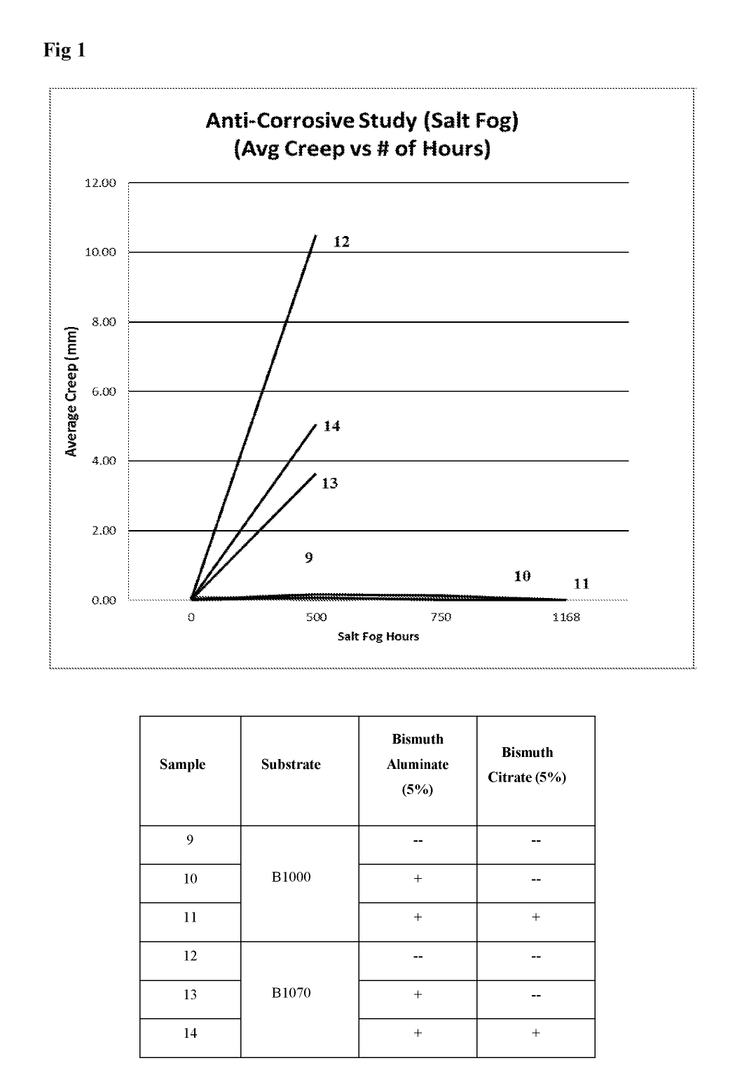

Powder formulations #9 to #14 were prepared using a standard commercially available polyurethane binder system with either bismuth aluminate (5%) or a combination of bismuth aluminate and bismuth citrate (total bismuth amount of 5%) as indicated in Table 4 below. These formulations were coated onto different substrates, i.e. test panels of iron-phosphate pretreated cold-rolled steel (B1000) or organic phosphate pretreated cold-rolled steel (B1050). The coated panels are scribed, and after 500, 750 and 1000 hours of salt fog exposure, the scribed panels were baked for 20 minutes at 180° C. The panels were then scraped and the creep from scribe was measured. The average creep from scribe is shown in FIG. 1.

TABLE 4
Powder Formulations for Corrosion Testing

| | | Bismuth Aluminate | Bismuth Citrate |
|---|---|---|---|
| Sample | Substrate | (5%) | (5%) |
| 9 | B1000 | −− | −− |
| 10 | | + | −− |
| 11 | | + | + |
| 12 | B1070 | −− | −− |
| 13 | | + | −− |
| 14 | | + | + |

### Example 5

### Barrier Properties

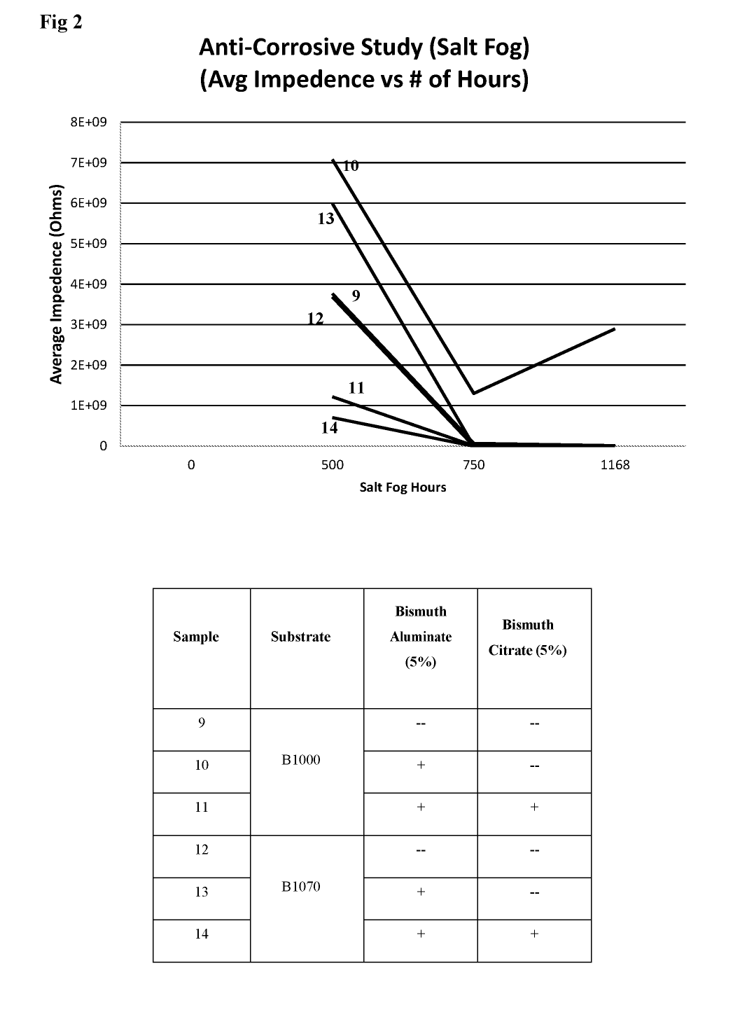

To assess corrosion resistance in terms of barrier properties, test panels were prepared as described in Example 4. A deep scratch all the way to the metal surface was made in each test panel and the panels were analyzed by EIS. Results are reported graphically in FIG. 2.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. (canceled)

2. (canceled)

3. A powder composition, comprising:
a binder resin component including at least one crosslinkable polymer resin component;
a crosslinking component; and
at least an inorganic bismuth-containing compound.

4. A method, comprising:
providing a metal substrate;
applying on the substrate a powder coating composition according to claim 1; and
heating the coated substrate to produce a cured coating.

5. The composition of claim 3, wherein the inorganic bismuth-containing compound is selected from bismuth silicate, bismuth magnesium aluminosilicate, bismuth aluminate, bismuth borate, bismuth manganate, bismuth hydroxide, bismuth trioxide, bismuth phosphate, and mixtures or combinations thereof.

6. The composition of claim 3, wherein the inorganic bismuth-containing compound is a bismuth salt of a metal oxyanion.

7. The composition of claim 3, wherein the inorganic bismuth-containing compound is bismuth aluminate, or a hydrate thereof.

8. The composition of claim 3, wherein the composition includes a combination of an inorganic bismuth-containing compound and an organic bismuth-containing compound.

9. (canceled)

10. The composition of claim 3, wherein the combination of an inorganic bismuth-containing compound and an organic bismuth-containing compound is a combination of an inorganic bismuth-containing compound, or a hydrate thereof, and bismuth citrate.

11. The composition of claim 3, wherein the combination of an inorganic bismuth-containing compound and an organic bismuth-containing compound is a combination of bismuth aluminate and bismuth citrate.

12. The composition of claim 3, further comprising:
a binder resin component comprising about 40 to 95% of a hydroxyl-functional polyester resin and 5 to 7% of an epoxy resin;
a crosslinking component comprising about 1 to 60% of the blocked polyisocyanate component; and
about 0.1 to 5% of an inorganic bismuth-containing compound.

13. (canceled)

14. (canceled)

15. (canceled)

16. The composition of claim 3, wherein a coating formed from the composition demonstrates average creep from scribe of less than about 3 mm after 500 hours of exposure to salt fog.

17. (canceled)

18. (canceled)

19. (canceled)
